(19) United States
(12) Patent Application Publication
(10) Pub. No.: US 2025/0202220 A1
(43) Pub. Date: Jun. 19, 2025

(54) Method for Interrupting a Circuit Breaker

(71) Applicant: XI'AN JIAOTONG UNIVERSITY, Xi'an (CN)

(72) Inventors: Fei Yang, Xi'an (CN); Mingzhe Rong, Xi'an (CN); Xiangyu Han, Xi'an (CN); Jinru Sun, Xi'an (CN); Hongbin Chen, Xi'an (CN); Yifei Wu, Xi'an (CN); Chunping Niu, Xi'an (CN); Xuliang Zhao, Xi'an (CN); Shengwei Liu, Xi'an (CN)

(21) Appl. No.: 18/973,191

(22) Filed: Dec. 9, 2024

(30) Foreign Application Priority Data
Dec. 8, 2023 (CN) 2023116786884

(51) Int. Cl. H02H 3/05; H02H 3/02; H02H 3/16

(52) U.S. Cl. CPC H02H 3/05; H02H 3/021; H02H 3/162

(57) ABSTRACT

The present disclosure discloses a method for interrupting a circuit breaker, wherein the circuit breaker comprises a transfer branch and a current-carrying branch which are connected in parallel, the transfer branch comprising an oscillation circuit formed by a transfer capacitor and an inductor and a conduction circuit connected in series with the oscillation circuit, and the method comprises the following steps: S100: when a fault current in the current-carrying branch decreases, controlling the conduction circuit in the transfer branch to conduct, and forming a loop by the conduction circuit after conduction with the oscillation circuit and the current-carrying branch; S200: forming a transfer current continuously oscillating through oscillating discharge of the oscillation circuit, and injecting the transfer current into the current-carrying branch through the loop.

### CROSS-REFERENCE TO RELATED APPLICATION

This application claims priority from the Chinese patent application 2023116786884 filed Dec. 8, 2023, the content of which is incorporated herein in the entirety by reference.

### TECHNICAL FIELD

The present disclosure belongs to the technical field of electric power equipment, and particularly relates to a method for interrupting a circuit breaker.

### BACKGROUND OF THE INVENTION

Traditional alternating current (AC) circuit breakers accomplish interruption by utilizing current zeros. Therefore, it is difficult to promptly interrupt fault currents with delayed zero-crossing phenomena, which do not have current zeros for several consecutive cycles. Allowing the fault current to develop until a current zero appears can further expand the fault scope, causing significant damage to the power system and related equipment. Short-circuit currents with delayed zero-crossing phenomena mostly occur in generator short-circuit faults, where the fault current during the short circuit is extremely high, thus placing higher demands on the interruption performance of circuit breakers. Currently, the common method for interrupting short-circuit currents with delayed zero-crossing is to use sulfur hexafluoride (SF6) circuit breakers to generate a very high arc voltage during the contact opening process to force the current to cross zero. However, this method requires an extremely high arc voltage and has a longer interruption time, typically exceeding two current cycles. Furthermore, if the fault current cannot be interrupted promptly at zero generated under the action of arc voltage, it will be difficult to interrupt the fault current. Additionally, the use of SF6 circuit breakers does not align with the environmental development trend in power equipment.

The above information disclosed in the Background section is only for enhancement of understanding of the background of the disclosure and therefore may contain information that does not constitute the prior art that is well known to those of ordinary skill in the art.

### SUMMARY

In response to the shortcomings in the prior art, an objective of the present disclosure is to provide a method for interrupting a circuit breaker, which is capable of providing a plurality of current zeros, thereby increasing the likelihood of circuit breaker interruption.

To achieve the above objective, the present disclosure provides the following technical solutions:
a method for interrupting a circuit breaker is provided, wherein the circuit breaker includes a transfer branch and a current-carrying branch which are connected in parallel, the transfer branch including an oscillation circuit formed by a transfer capacitor and an inductor and a conduction circuit connected in series with the oscillation circuit, and the method includes the following steps:
S100: when a fault current in the current-carrying branch decreases, controlling the conduction circuit in the transfer branch to conduct, and forming a loop by the conduction circuit after conduction with the oscillation circuit and the current-carrying branch;
S200: forming a transfer current continuously oscillating through oscillating discharge of the oscillation circuit, and injecting the transfer current into the current-carrying branch through the loop; and
S300: reversely superimposing the transfer current with the fault current in the current-carrying branch during a continuous oscillation process to enable the current-carrying branch to generate a plurality of current zeros.

Preferably, in step S100, when the fault current decreases to a certain characteristic value, the conduction circuit in the transfer branch is conducted.

Preferably, the conduction circuit includes reversely parallel-connected controllable power electronic devices which are connected in series with the transfer capacitor and the inductor.

Preferably, the conduction circuit further includes a bridge circuit formed by the controllable power electronic devices.

Preferably, the circuit breaker further includes a current-limiting branch which is connected in parallel with the transfer branch and the current-carrying branch.

Preferably, the circuit breaker further includes a freewheeling branch connected in parallel with the current-carrying branch.

Preferably, the circuit breaker further includes a voltage-limiting branch connected in parallel with the current-carrying branch.

Compared with the prior art, the beneficial effects brought by this disclosure are as follows: this method can generate a plurality of current zeros in a short period of time, thus providing the mechanical switch with multiple opportunities for zero-crossing interruption, and improving the interruption reliability of the circuit breaker.

### BRIEF DESCRIPTION OF DRAWINGS

FIG. 1 is schematic diagram of a circuit structure of a current transfer-type circuit breaker for large current delayed zero-crossing according to an embodiment of the present disclosure;

FIG. 2A is a schematic diagram of the circuit breaker shown in FIG. 1 in a normal current-flowing phase;

FIG. 2B is a schematic diagram of the circuit breaker shown in FIG. 1 in a transfer current injection phase;

FIG. 2C is a schematic diagram of the circuit breaker shown in FIG. 1 in a current-limiting phase;

FIG. 2D is a schematic diagram of the circuit breaker shown in FIG. 1 in an interruption completion phase;

FIG. 3 is a schematic diagram of a first current half-wave of a transfer current on a current-carrying branch in a direction opposite to that of a fault current according to an embodiment of the present disclosure;

FIG. 4 is a schematic diagram of a circuit structure of a current transfer-type circuit breaker for large current delayed zero-crossing according to another embodiment of the present disclosure;

FIG. 5A is a schematic diagram of the circuit breaker shown in FIG. 4 in a normal current-flowing phase;

FIG. 5B is a schematic diagram of the circuit breaker shown in FIG. 4 when the fault current flows in from the right side;

FIG. 5C is a schematic diagram of the circuit breaker shown in FIG. 4 when the fault current flows in from the left side;

FIG. 5D is a schematic diagram of the energy dissipation of the circuit breaker shown in FIG. 4;

FIG. 6 is a structural schematic diagram of a circuit breaker including a freewheeling branch according to another embodiment of the present disclosure;

FIG. 7 is a structural schematic diagram of a circuit breaker including a voltage-limiting branch according to another embodiment of the present disclosure;

FIG. 8 is a schematic diagram of a generator-source short-circuit fault current waveform with a delayed zero-crossing phenomenon according to another embodiment of the present disclosure;

FIG. 9A is a schematic diagram of a waveform of a transfer current with a plurality of oscillations on a transfer branch according to another embodiment of the present disclosure;

FIG. 9B is a schematic diagram of a waveform where the transfer current and the short-circuit current are superimposed on the current-carrying branch to produce a plurality of current zeros;

FIG. 9C is a partially enlarged schematic diagram of the waveform shown in FIG. 9B;

FIG. 10A is a schematic diagram of curves of branch currents when the current transfer-type circuit breaker interrupts the fault current according to another embodiment of the present disclosure;

FIG. 10B is a partially enlarged diagram of the current transfer phase in the current interruption process; and

FIG. 11 is a schematic diagram of waveforms of branch currents when a mechanical switch performs zero-crossing interruption at the second current zero according to another embodiment of the present disclosure.

### DETAILED DESCRIPTION OF THE INVENTION

Specific embodiments of the present disclosure will be described in detail below with reference to the accompanying drawings 1 to 11. While specific embodiments of the disclosure are illustrated in the drawings, it should be understood that the disclosure may be embodied in various forms and should not be limited to the embodiments set forth herein. Rather, these embodiments are provided in order to enable a more thorough understanding of the present disclosure and to fully convey the scope of the present disclosure to those skilled in the art.

It should be noted that certain words are used in the specification and claims to refer to specific components. It will be understood by those skilled in the art that the skilled person may refer to the same component with different terms. The present specification and claims do not use differences in terms as a way to distinguish components, but use differences in functions of components as a criterion for distinguishing them. “Includes” or “including”, as referred to throughout the specification and claims, is an open-ended language that is to be interpreted as “including, but not limited to.” The following description is to describe preferred embodiments for carrying out the present disclosure, but the description is for the purpose of general principles of the specification and is not intended to limit the scope of the present disclosure. The scope of the present disclosure is intended as defined by the appended claims.

In order to facilitate an understanding of embodiments of the present disclosure, specific embodiments will now be further explained by way of example with reference to the accompanying drawings, which are not to be construed as limiting embodiments of the present disclosure.

In one embodiment, the present disclosure provides a method for interrupting a circuit breaker, wherein the circuit breaker includes a transfer branch and a current-carrying branch which are connected in parallel, the transfer branch including an oscillation circuit formed by a transfer capacitor and an inductor and a conduction circuit connected in series with the oscillation circuit, and the method includes the following steps:
S100: when a fault current in the current-carrying branch decreases, the conduction circuit in the transfer branch is controlled to conduct, and a loop is formed by the conduction circuit after conduction with the oscillation circuit and the current-carrying branch;
S200: a transfer current continuously oscillating is formed through oscillating discharge of the oscillation circuit, and the transfer current is injected into the current-carrying branch through the loop; and
S300: the transfer current is reversely superimposed with the fault current in the current-carrying branch during a continuous oscillation process to enable the current-carrying branch to generate a plurality of current zeros.

It should be noted that the method for interrupting a circuit breaker does not utilize a freewheeling branch, thus significantly reducing its control complexity and making it more conducive to achieving reliable control in the complex electromagnetic environment at the generator outlet. Furthermore, compared to the prior art, the method for interrupting a circuit breaker belongs to an interrupting method with a plurality of current zeros, which greatly enhances the reliability of current interruption. For more details, please refer to the descriptions of multiple embodiments focusing on current zeros provided later.

In another embodiment, the conduction circuit includes reversely parallel-connected controllable power electronic devices which are connected in series with the transfer capacitor and the inductor.

In this embodiment, the reversely parallel-connected controllable power electronic device includes any one of a thyristor, a MOSFET, an IGCT, an IGBT, and an IEGT. In the following, the present disclosure uses thyristors as an example to describe in detail the interruption principle and the interruption process of the current transfer-type circuit breaker.

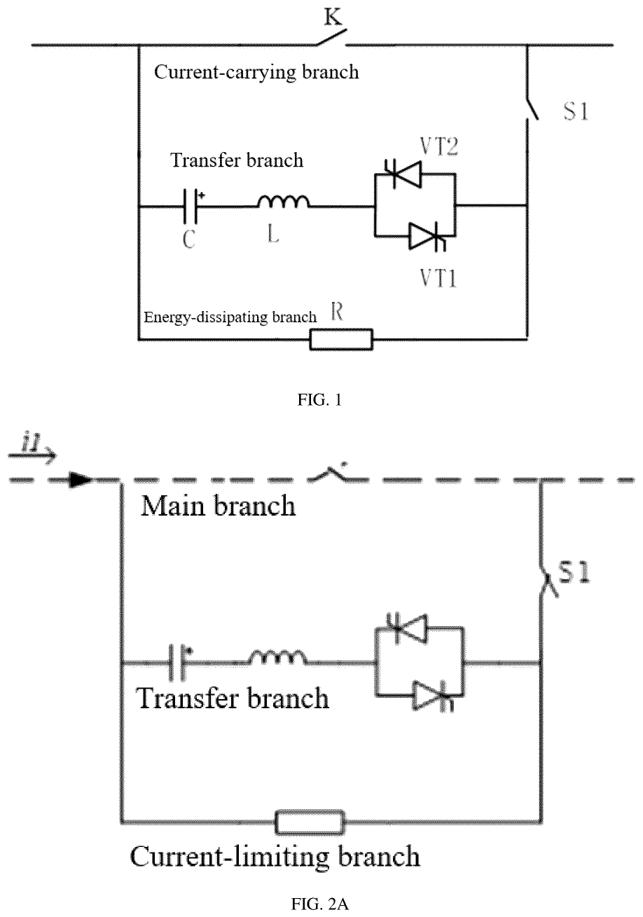

The circuit breaker shown in FIG. 1 includes a transfer branch, a current-carrying branch and a current-limiting branch, wherein the current-carrying branch includes a mechanical switch, the current-limiting branch includes a current-limiting resistor, and the transfer branch includes a transfer capacitor and an inductor, which are connected in series with a pair of reversely parallel-connected thyristors VT1 and VT2 after being connected in series. In FIG. 1, the topology of the circuit breaker does not include a freewheeling branch, which significantly reduces the control complexity of the method for interrupting a circuit breaker disclosed in the present disclosure, making it more favorable for achieving reliable control in the complex electromagnetic environment at the generator outlet.

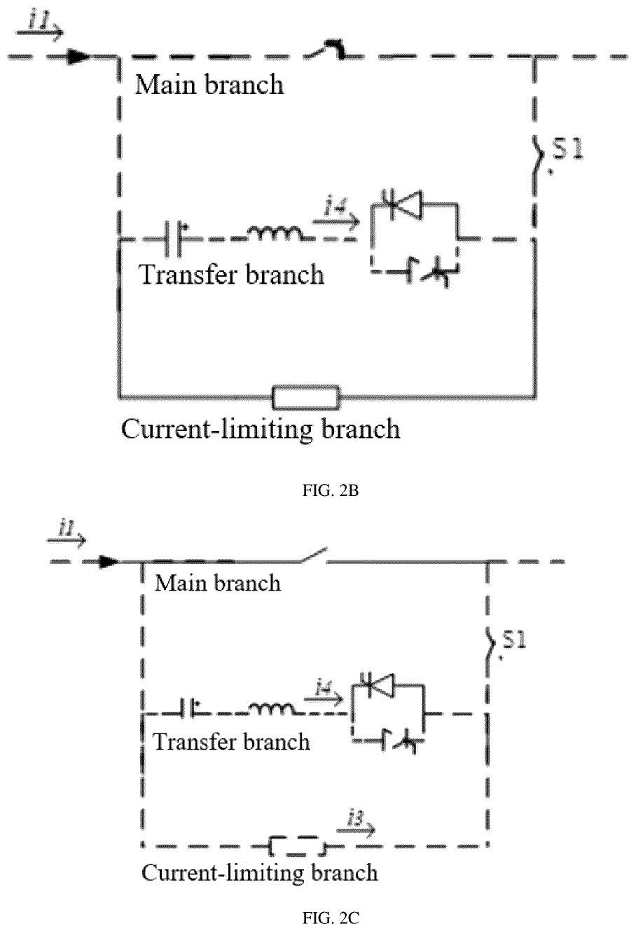

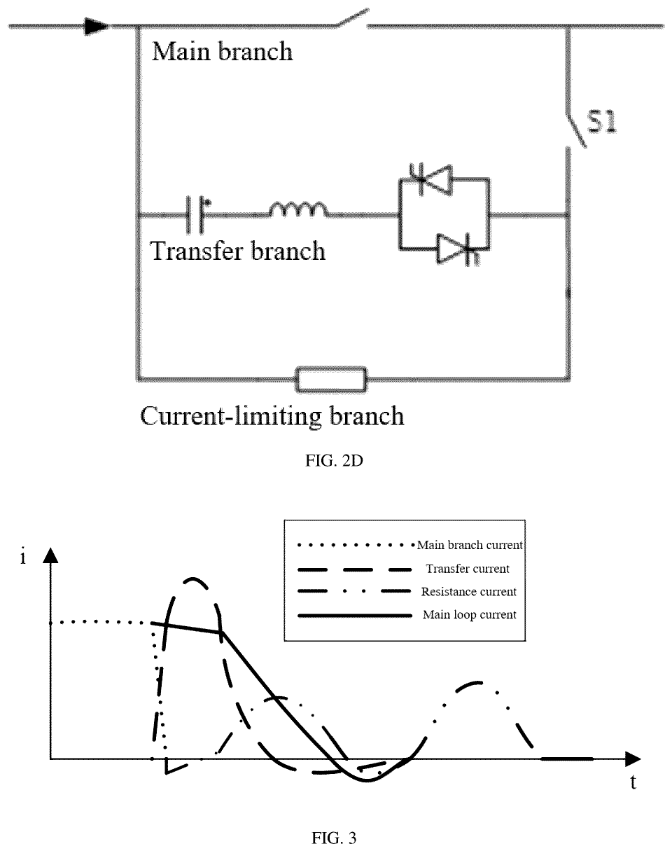

The interruption process of the circuit breaker shown in FIG. 1 can be divided in particular into four operating phases, which are shown in FIGS. 2A to 2D.

FIG. 2A shows a normal current-flowing phase in which a normally operating load current flows from left to right into the current-carrying branch and is conducted by the mechanical switch in the current-carrying branch, and the flowing path of the load current is shown as a dashed line in FIG. 2A.

FIG. 2B shows a transfer current injection phase. During this phase, a relay protection device of the circuit breaker continuously monitors the operating condition of the circuit breaker. Upon detecting the occurrence of a fault (a fault current shown as i1 in the figure), the relay protection device issues a command to control the mechanical switch to open. However, due to the presence of an arc, the current-carrying branch will still remain conducting for a short period.

To achieve current zero-crossing in the current-carrying branch, it is necessary to inject a current which is equal in magnitude but in a direction opposite to that of the fault current, so that when they are superimposed, an equivalent current in the current-carrying branch becomes zero. For the scenario shown in the figure, where the fault current flows from left to right, according to the relay protection strategy, at a specific value during the decreasing phase of the fault current, the relay protection device sends conduction signals to thyristors the VT1 and VT2 to make them conduct. The pre-charged transfer capacitor and inductor perform oscillating discharge, and the transfer branch and the current-carrying branch form a discharge loop. The transfer capacitor is charged with positive on the right and negative on the left, thus the direction of the transfer current is counterclockwise as shown by i4 in the figure. The transfer current flows from right to left in the current-carrying branch, and is opposite to the direction of the fault current. The transfer current increases from zero, with its amplitude greater than that of the fault current at this moment. Therefore, the current in the current-carrying branch gradually decreases until it reaches zero for zero-crossing interruption, and the fault current is transferred from the current-carrying branch to the transfer branch and the current-limiting branch.

Wherein, the specific value during the decreasing phase of the fault current is determined by the relay protection strategy. The fundamental principle is that this specific value should be less than the magnitude of the transfer current, and the time from this specific value to the minimum fault current should not be too short. For example, if the peak value of the transfer current is 30 kA, to ensure that the transfer current is greater than the fault current, thereby definitely achieving zero-crossing of the current in the current-carrying branch, a certain margin needs to be maintained, such as setting the specific value to be less than 25 kA. Another example is that if the minimum fault current is 5 kA, and it takes 1 ms for the fault current to decrease from 10 kA to 5 kA, while the relay protection action time and the action time of the power electronic devices require 1 ms, the specific value should be greater than 10 kA. In summary, as determined by the control strategy, during the period when the fault current decreases from 25 kA to 10 kA (in actual circuit breaker operation, factors such as arcing time and energy consumption by the current-limiting resistor also need to be considered, resulting in a determined value), the relay protection device sends a conduction signal to the thyristor to make it conduct.

Similarly, when the load current flows into the current-carrying branch from right to left and a fault occurs to generate a fault current, the situation is controlled by the relay protection device. Only the thyristor VT1 is given a conduction signal before the mechanical switch in a main branch opens. Since the VT2 does not receive a trigger signal and cannot be conducted, the transfer capacitor and inductor only oscillate for half a cycle. After the voltage across the transfer capacitor oscillates for half a cycle, it changes from positive on the right and negative on the left to positive on the left and negative on the right. During subsequent discharging, the first current discharged by the transfer capacitor flows in a clockwise direction, flowing from left to right in the current-carrying branch, opposite to the direction of the fault current, which enables the current in the current-carrying branch to gradually decrease to zero.

Above, in the current transfer-type circuit breaker shown in FIG. 1, by controlling the transfer capacitor to oscillate once before current transfer and adjusting the charging direction of the capacitor, the transfer current generated in the transfer branch can always maintain a direction opposite to that of the fault current regardless of whether the fault current in the current-carrying branch flows from right to left or from left to right.

Further, when the transfer current generated by the transfer capacitor and inductor oscillation flows into the current-carrying branch via the thyristor VT1 or VT2, due to the opposite direction of the transfer current compared to the fault current in the current-carrying branch, an equivalent current resulting from the superimposition of the transfer current and the fault current gradually decreases until a plurality of current zeros are generated on the current-carrying branch, the mechanical switch on the current-carrying branch can be provided with multiple opportunities of zero-crossing interruption, so that the interruption probability of the circuit breaker can be greatly improved, and thus the phenomenon of delayed zero-crossing of the conventional AC circuit breaker can be effectively overcome.

FIG. 3 shows a scenario where a first current half-wave of a transfer current on a current-carrying branch is in a direction opposite to that of a fault current. In FIG. 3, during a certain period of the decreasing phase of the fault current (also known as a main loop current), a conduction signal is sent to the power electronic devices of the transfer branch. This results in oscillating discharge of the transfer capacitor and inductor, thus generating a transfer current. The transfer current flows into the current-carrying branch and is opposite to the direction of the fault current. The equivalent current resulting from the superimposition of the transfer current and the fault current decreases gradually, and a plurality of current zeros are generated. Subsequently, the fault current is transferred to the transfer branch and the current-limiting branch, and is finally interrupted by the auxiliary switch S1.

FIG. 2C shows a current-limiting phase, the mechanical switch on the current-carrying branch is interrupted at a certain current zero resulting from the superimposition of the transfer current and the fault current, and subsequently, the fault current is transferred to the transfer branch and the current-limiting branch, where the fault current is limited, and the current energy is dissipated by the current-limiting branch;

FIG. 2D shows an interruption completion phase, the current-limited fault current is then interrupted by the auxiliary switch S1, and the entire fault interruption process ends.

It should be noted that the thyristor in the circuit shown in FIG. 1 may be replaced with any one of the following, including MOSFET, IGCT, IGBT, IEGT, etc., and the operation principle and process are the same, and will not be described in detail here.

In another embodiment, the conduction circuit further includes a bridge circuit formed by controllable power electronic devices.

In this embodiment, the circuit breaker shown in FIG. 4 includes a transfer branch, a current-carrying branch and a current-limiting branch, wherein the current-carrying branch includes a mechanical switch, the current-limiting branch includes a current-limiting resistor, and the transfer branch includes a transfer capacitor and an inductor, which are connected in series and then connected in parallel with a bridge circuit formed by a thyristor VT1, a thyristor VT2, a thyristor VT3 and a thyristor VT4.

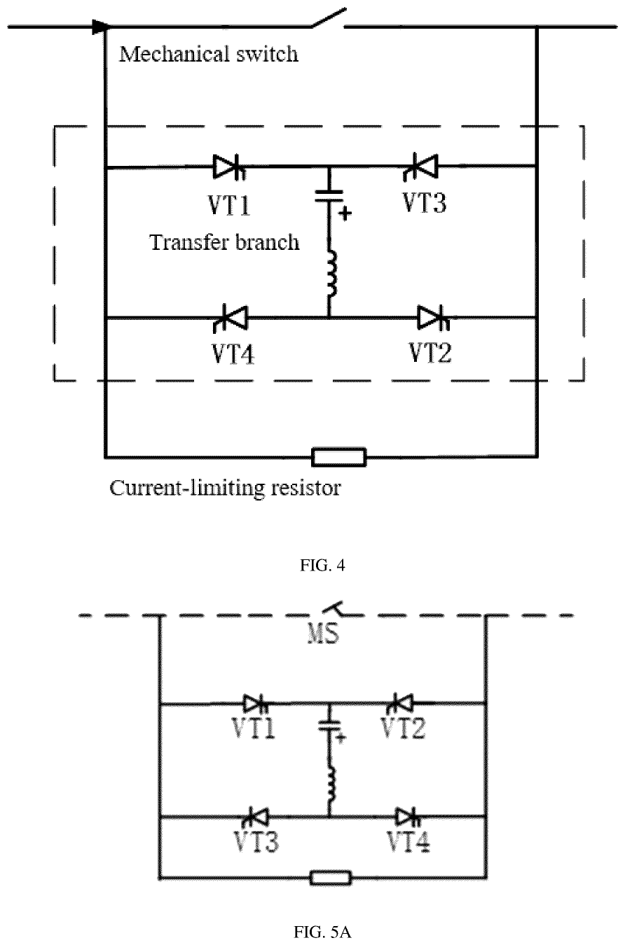

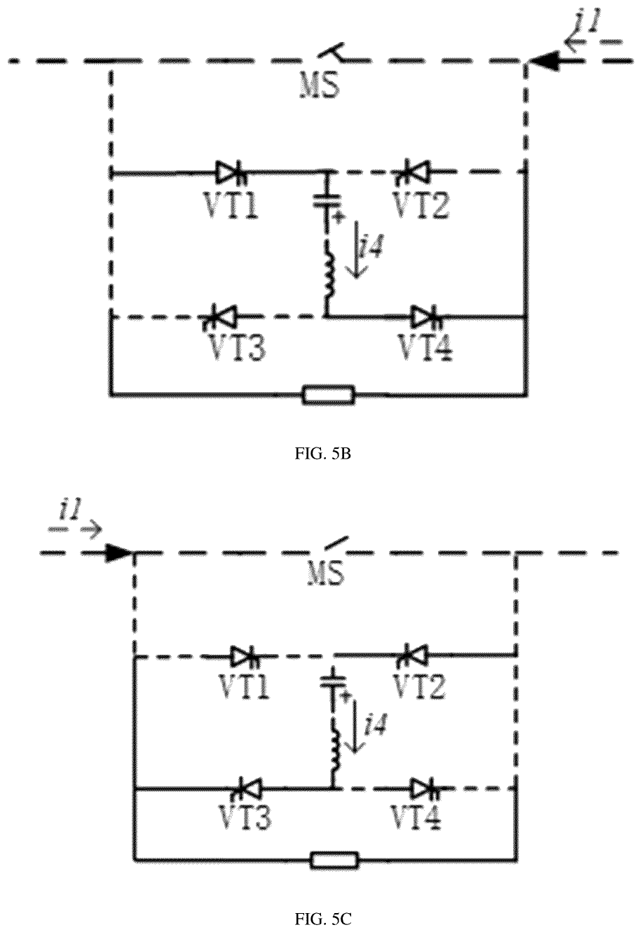

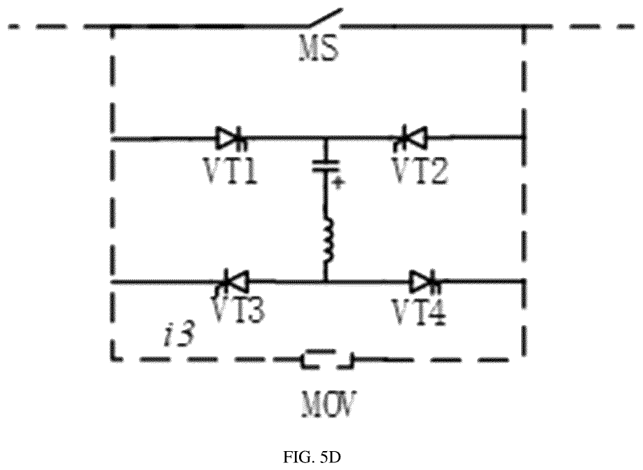

The interruption process of the circuit breaker shown in FIG. 4 is also divided into four operating phases, which are shown in FIGS. 5A to 5D, respectively.

FIG. 5A shows a normal current-flowing phase; in which a load current is conducted by the current-carrying branch during normal flowing, the load current being shown as a dashed line in FIG. 5A.

FIG. 5B shows a transfer current injection phase, in this phase, when the fault current i1 flows into the transfer branch and flows from right to left, the thyristors VT2 and VT3 are controlled to conduct, the transfer capacitor and the inductor oscillate to generate a transfer current, and the flowing path of the transfer current is shown by the dashed line in FIG. 5B, and the transfer current flows from left to right after flowing into the current-carrying branch, and is opposite to the flowing direction of the fault current i1 at this time. An equivalent current after the superimposition of the two gradually decreases on the current-carrying branch until a plurality of current zeros are generated on the current-carrying branch.

In FIG. 5C, when the fault current i1 flows from left to right, the thyristors VT1 and VT4 are controlled to conduct, the transfer capacitor and inductor oscillate to generate a transfer current, the flowing path of the transfer current is shown as a dashed line in FIG. 5C, the transfer current flows from right to left after flowing into the current-carrying branch, and is opposite to the flowing direction of the fault current i1 at this time. An equivalent current after the superimposition of the two gradually decreases on the current-carrying branch until a plurality of current zeros are generated on the current-carrying branch. The mechanical switch on the current-carrying branch can be provided with multiple opportunities of zero-crossing interruption, so that the interruption probability of the circuit breaker can be greatly improved, and thus the phenomenon of delayed zero-crossing of the conventional AC circuit breaker can be effectively overcome.

FIG. 5D shows a dissipation phase in which the mechanical switch on the current-carrying branch is interrupted at a certain current zero resulting from the superimposition of the transfer current and the fault current, after which the fault current is transferred to the transfer branch and the current-limiting branch, where the fault current is limited, and the current energy is dissipated by the current-limiting branch; the current-limited fault current is then interrupted by the auxiliary switch S1, and the entire fault interruption process ends.

Similarly, the thyristor in the circuit shown in FIG. 4 may be replaced with any one of the following, including MOSFET, IGCT, IGBT, IEGT, etc., and the operation principle and process are the same, and will not be described in detail here.

In another embodiment, the circuit breaker further includes a freewheeling branch connected in parallel with the current-carrying branch.

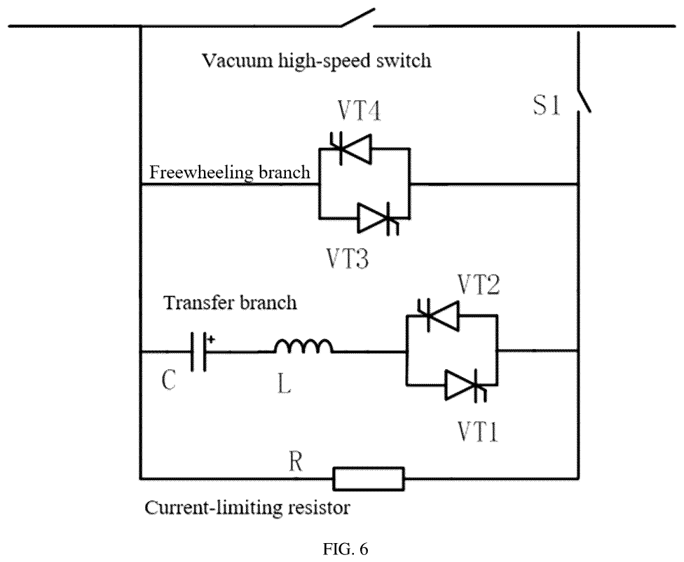

In this embodiment, the freewheeling branch includes a reversely parallel-connected diode (as shown in FIG. 6), which may be replaced by any one of a semi-controlled power electronic device and a fully controlled power electronic device. By setting up the freewheeling branch and sending a conduction signal to the thyristor of the freewheeling branch during the injection of the transfer current, since the amplitude of the transfer current is greater than that of the fault current at this time, when the transfer current rises to equal the amplitude of the fault current, the current-carrying branch is interrupted at zero current. The portion of the transfer current above the fault current is conducted by the freewheeling branch until the transfer current decreases again to equal the fault current, at which point the freewheeling branch current is interrupted at zero current. Since the freewheeling branch is connected in parallel with the two sides of the current-carrying branch, the voltages across the parallel branches are equal, thereby clamping the voltage of the current-carrying branch to the conduction voltage drop of the thyristor in the freewheeling branch. This allows the voltage of the switch in the current-carrying branch during the conduction of the freewheeling branch to be the conduction voltage drop of the thyristor, thus providing a cooling time for the dielectric recovery of the mechanical switch in the current-carrying branch.

In another embodiment, the circuit breaker further includes a voltage-limiting branch connected in parallel with the current-carrying branch.

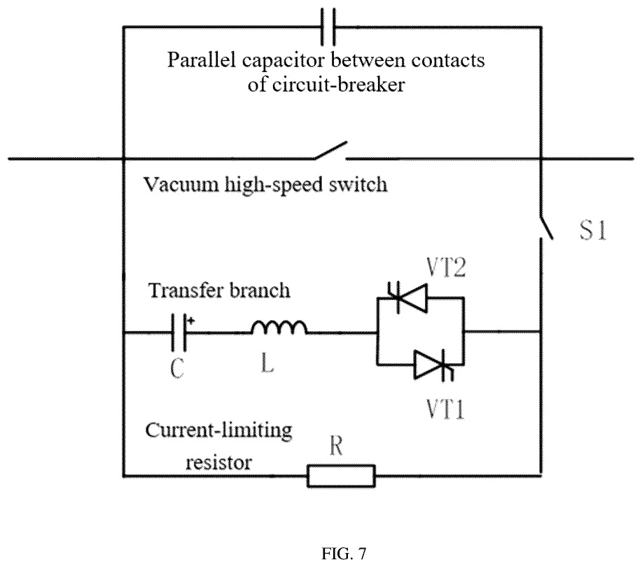

In the present embodiment, as shown in FIG. 7, the voltage-limiting branch includes a capacitor. In addition, the voltage-limiting branch may replace the capacitor with a resistor or a combination of the capacitor and the resistor. By providing the voltage-limiting branch, the interruption voltage of the mechanical switch can be limited.

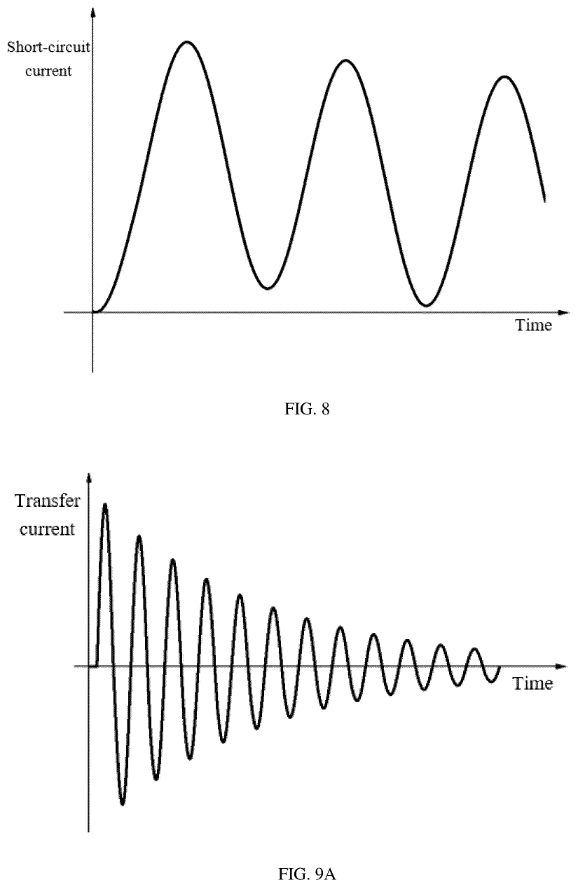

FIG. 8 is a schematic diagram of a generator-source short-circuit fault current waveform with a delayed zero-crossing phenomenon according to an embodiment of the present disclosure. As can be seen from FIG. 8, the short circuit current does not have a current zero for at least two cycles after the short circuit occurs. This characteristic makes it impossible for traditional AC circuit breakers that utilize current zeros to effectively interrupt the fault current. In this disclosure, the delayed zero-crossing phenomenon refers to the situation where the direct current (DC) component of the short-circuit current is excessively large when a fault occurs, with the amplitude of the DC component exceeding the amplitude of the AC component, resulting in the fault current not crossing zero for multiple consecutive cycles. The delayed zero-crossing phenomenon typically occurs in generator short-circuit faults, where the DC component of the short-circuit current decays more slowly than the AC component, causing the DC component to be larger than the AC component for a period of time.

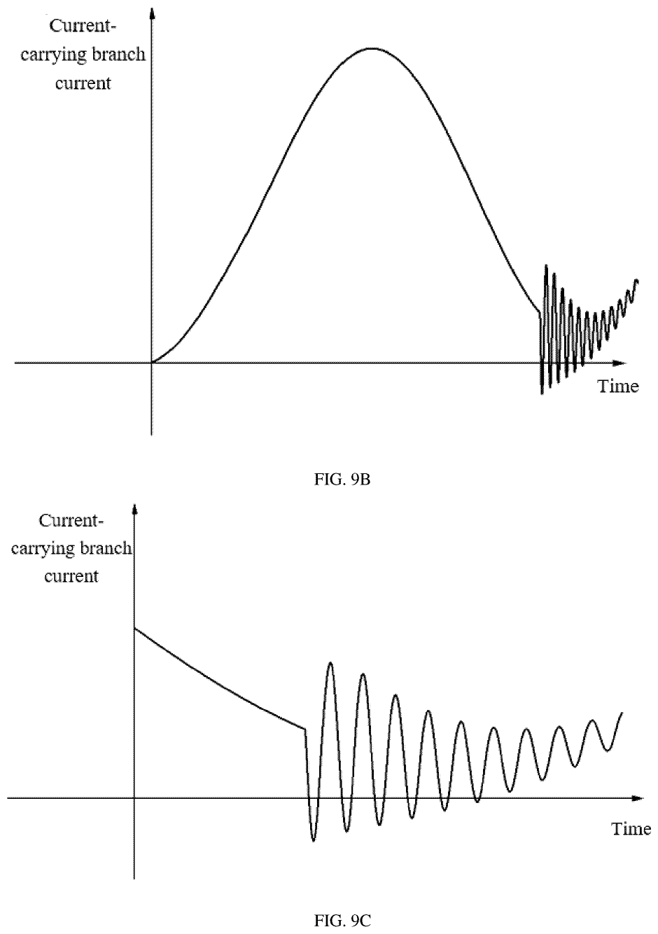

FIGS. 9A to 9C are a schematic diagram of the waveform of the transfer current with a plurality of oscillations on the transfer branch and schematic diagrams of the current of the current-carrying branch according to one embodiment of the present disclosure, wherein,

FIG. 9A shows the waveform of the transfer current with a plurality of oscillations. In practical operation, a conduction signal is sent to the controlled element of the transfer branch to make it conduct, and this conduction signal is continuously sent to the controlled element, so that the transfer capacitor and inductor continuously oscillate to discharge, thus generating the transfer current. Until the current in the current-carrying branch reaches zero and is interrupted, no interruption signal is sent to the controlled element, and the current conduction path remains open. The transfer capacitor and inductor are relatively small, resulting in a very short oscillation period, and the transfer current can oscillate for multiple times in a short period. The transfer current with a plurality of oscillations is superimposed with the fault current in the current-carrying branch. Since the amplitude of the transfer current is greater than the fault current at this time, and the transfer current oscillates for multiple times in a short period, a plurality of current zeros are generated in the equivalent current on the current-carrying branch;

FIG. 9B is a schematic diagram of an entire waveform of the current of the current-carrying branch according to an embodiment of the disclosure, and FIG. 9C is a partially enlarged diagram of the current zero-crossing generating section in the current-carrying branch, and the short-circuit currents shown in FIGS. 9B and 9C are the same generator source short-circuit fault current as that shown in FIG. 8;

In summary, as can be seen from FIGS. 9A to 9C, the superimposition of the transfer current and the fault current on the current-carrying branch causes a plurality of current zeros to occur in a short period of time in the current that originally had no current zeros. Therefore, for the delayed zero-crossing phenomenon shown in FIG. 8, the method for interrupting a circuit breaker disclosed in this disclosure solves the problem that the traditional AC circuit breakers are unable to effectively interrupt fault currents.

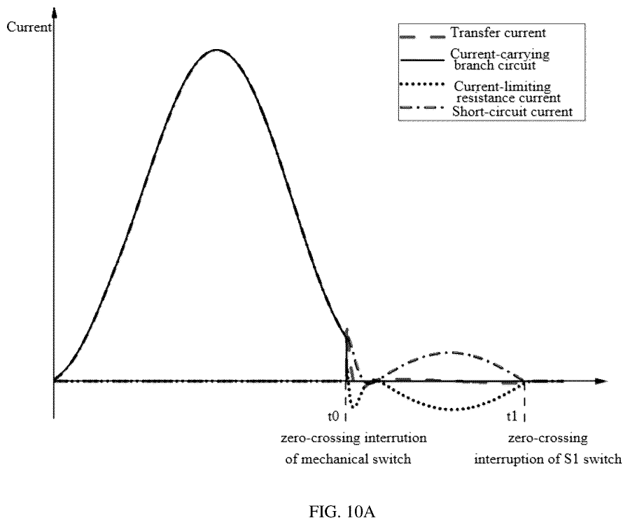

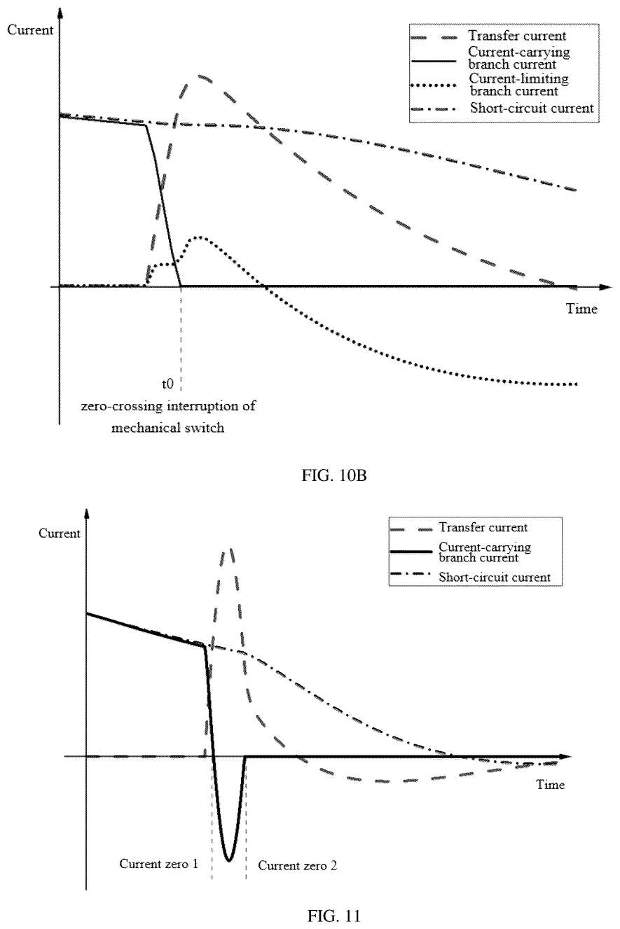

FIGS. 10A-10B are schematic diagrams illustrating the curves of the branch currents when the current transfer-type circuit breaker interrupts the fault current according to an embodiment of the present disclosure. Wherein, FIG. 10A is a current interruption overall waveform, and FIG. 10B is a partially enlarged diagram of a current transfer phase in the current interruption process (time to in FIG. 10B has the same meaning as time to in FIG. 10A). Two special positions are marked in FIG. 10A, at time t0, the mechanical switch of the current-carrying branch performs current zero-crossing interruption; at time t1, the fast switch S1 performs current zero-crossing interruption. During normal current-flowing, the load current is conducted through the mechanical switch of the current-carrying branch; when the fault current is interrupted, the controlled element is conducted, subsequently the transfer capacitor and inductor oscillate to discharge so as to generates a transfer current, the transfer branch and the current-carrying branch form a flowing path for the transfer current, the direction of the transfer current is opposite to the direction of the fault current, the transfer current and the fault current are superimposed such that the equivalent current flowing through the mechanical switch of the current-carrying branch gradually decreases to zero and zero-crossing interruption is performed, then the fault current will flow through an energy-dissipating branch, and after the energy-dissipating branch consumes additional energy, the fault current is interrupted by the auxiliary switch S1.

FIG. 11 is a schematic diagram of waveforms of branch currents when a mechanical switch performs zero-crossing interruption at the second current zero according to an embodiment of the present disclosure. In FIG. 11, the transfer current oscillates for multiple times during the fault current reduction period, forming a plurality of current zeros on the current-carrying branch. The mechanical switch in the current-carrying branch can interrupt the current at different current zeros based on its own interrupting capability. In the example given in FIG. 11, due to different control strategies, the mechanical switch in the current-carrying branch chooses not to interrupt at the first current zero and subsequently completes the interruption at the second current zero. The voltage-current characteristics at different current zeros for interruption are different, corresponding to different interruption strategies.

Although embodiments of the present disclosure have been described above with reference to the accompanying drawings, the present disclosure is not limited to the above-described specific embodiments and application fields, and the above-described specific embodiments are merely schematic and instructive, and are not limiting. Those skilled in the art can make many forms under the inspiration of the present specification and without departing from the scope of the claims of the present disclosure, which are all within the scope of the protection of the present disclosure.

1. A method for interrupting a circuit breaker, wherein the circuit breaker comprises a transfer branch and a current-carrying branch which are connected in parallel, the transfer branch comprising an oscillation circuit formed by a transfer capacitor and an inductor and a conduction circuit connected in series with the oscillation circuit, and the method comprises the following steps:
S100: when a fault current in the current-carrying branch decreases, controlling the conduction circuit in the transfer branch to conduct, and forming a loop by the conduction circuit after conduction with the oscillation circuit and the current-carrying branch;
S200: forming a transfer current continuously oscillating through oscillating discharge of the oscillation circuit, and injecting the transfer current into the current-carrying branch through the loop; and
S300: reversely superimposing the transfer current with the fault current in the current-carrying branch during a continuous oscillation process to enable the current-carrying branch to generate a plurality of current zeros.

2. The method according to claim 1, wherein, preferably, in step S100, when the fault current decreases to a certain characteristic value, the conduction circuit in the transfer branch is conducted.

3. The method according to claim 1, wherein the conduction circuit comprises reversely parallel-connected controllable power electronic devices which are connected in series with the transfer capacitor and the inductor.

4. The method according to claim 1, wherein the conduction circuit further comprises a bridge circuit formed by the controllable power electronic devices.

5. The method according to claim 1, wherein the circuit breaker further comprises a current-limiting branch which is connected in parallel with the transfer branch and the current-carrying branch.

6. The method according to claim 1, wherein the circuit breaker further comprises a freewheeling branch connected in parallel with the current-carrying branch.

7. The method according to claim 1, wherein the circuit breaker further comprises a voltage-limiting branch connected in parallel with the current-carrying branch.
